(19) United States
(12) Patent Application Publication
(10) Pub. No.: US 2010/0307179 A1
(43) Pub. Date: Dec. 9, 2010

(54) Decorative and functional cabinet for through the wall air conditioners

(75) Inventor: Melissa Fava, Centerport, NY (US)

Correspondence Address: John F. Vodopia, 54 Cherry Lane, Huntington, NY, 11743, US

(73) Assignee: VioletStar Goods, Inc.

(21) Appl. No.: 12/455,894

(22) Filed: Jun. 9, 2009

(51) Int. Cl. F25D 23/00; B23P 19/04

(52) U.S. Cl. 62/262; 29/700

(57) ABSTRACT

A cabinet for covering an air conditioner mounted upon and extending through an opening in a wall separating an enclosed inside environment from an outside environment. The cabinet is readily opened to facilitate active air conditioner operation and readily closed to prevent communication of the outside environment with the inside environment when the air conditioner is inactive. The cabinet includes a planar top portion, a planar left side portion a planer bottom portion disposed opposite the planar top portion, a planar right side portion and an outer facing surface interconnected to form the cabinet structure. At least one angled cabinet-mounting member is attached to the planar top portion and configured to meet and cooperate with at least one angled wall-mounting member fixed to the wall, thereby securing the cabinet to the wall. At least one set of doors is attached to the outer facing surface and configured to be opened and closed.

### BACKGROUND OF THE INVENTION

The present invention broadly relates to through-the-wall air conditioners and, more particularly, relates to a cabinet system including a ready-made, wall-mountable cabinet configured to simply attach to a wall using a set of complementary readymade angled mounting members, whereby cabinet sealably covers and isolates the air conditioner in an off state, opens to cooperate with and enable air conditioner functional operation in an on state, and exhibits a desirable decor and ornamental design characteristics in both states.

Installed “through-the-wall” air conditioners are often an eyesore in otherwise lovely rooms and indoor spaces in which they are installed. Typically, these air conditioners are installed in unobstructed locations within a room, for example, a center of a dining room wall. As such, their presence often clashes with the room's inherent feel or aesthetic theme. Such air conditioner cannot be blocked from view, because blocking or covering during active air conditioner operation would impair air flow and therefore intended operation. For that matter, such through-the-wall air conditioners are always present, i.e., they are typically not removed from their installed locations in off seasons.

Homeowners are known to go to extreme efforts in attempts to mediate the affect of through-the-wall air conditioners on a room's décor. The inventor herein has observed homeowners wrapping through-the-wall air conditioners in gift wrap during the holidays, hanging pictures over the through-the-wall air conditioner unit, implementing coverings from cardboard, hanging curtains or other coverings of various fabrics, plastics, shrink wraps, etc. But while such attempted solutions prevent draft, and may avoid clashing with a natural décor of a room, they are not known to do so in a way that provides a year round solution, i.e., where the air conditioner can be covered during both “use” and “non-use” periods. Such coverings are not readily attached and detached at a homeowner's whim.

Commercial covers for covering through-the-wall air conditioner are also known, but their use is limited because they are typically attached in such a way that renders the covered though-the-wall air conditioner unusable while the cover is installed, and typically sealed to the wall to prevent drafts. That is, because conventional air conditioner covers are typically employed to prevent drafts from passing through the air conditioner, or around the air conditioner from the outer environment, their use is mostly limited to off seasons, where the covers must be removed prior to air conditioner use in active seasons. Covers generally comprise some type of fabric, and may include some type of fastening means, such as tape, to sealably secure a cover perimeter to the wall to prevent or minimize drafts.

In one example, U.S. Pat. No. 4,389,827, issued Jun. 28, 1983 (the '827 patent), discloses a through-the-wall air conditioner cover kit for preventing heat loss and covering a through-the-wall air conditioner unit. The kit comprises a rigid foamed polymeric cover piece and an attachment means comprising a backing having a layer of pressure sensitive adhesive on one side and sealing means on the opposite side. The cover piece is box-like, and is not configured to be aesthetically pleasing or in any way cooperate with the room decor. For that matter, as sealed, the cover cannot be used while the air conditioner is operational.

U.S. Pat. No. 4,325,229, issued Apr. 20, 1982 (the '229 patent), discloses an interior air conditioner cover that is assertedly weather tight, and configured to overlay a through-the-wall air conditioner protruding into a room interior. The cover comprises a peripheral sealing gasket to tightly fit against the moulding or wall surfaces surrounding the opening for the air conditioner. The gasket tightly seals the entire unit to provide for a draft free, insulated cover. The use of the draft free insulated cover reduces heat loss through the air conditioner openings and through gaps between the air conditioner housing and edges of the wall opening that the air conditioner extends through. But like the '827 patent, the '229 patent's air conditioner cover is not for use with the air conditioner while it is operational.

U.S. Design Pat. No. D394,901, issued Jun. 2, 1998 (the '901 patent) discloses a box-like through-the-wall air conditioner cover frame that is fixedly mounted on the wall over the portion of the air conditioner that protrudes, and includes a cover plate that is removably fixed to the cover frame by means of 4 screws. The plate appears to require removal of the 4 screws to remove the plate for intended use. The '901 patent does not appear to be directed to matching or cooperating with a décor or theme of a room in which it is installed.

US Patent Application Publication Number 2007/0011930, published Jan. 18, 2007 (the '930 application), discloses an air conditioner cover kit for seasonal use. That is, the kit comprises a square or rectangular frame that breaks down into a plurality of slats that are joined by fasteners and snapped together with reusable hinges and mounted over the through-the-wall air conditioner when the air conditioner is in a non-use state. The '930 application does not appear to be readily usable. Like other known air conditioner covers, the cover disclosed by the '930 application is not configured for easy use when the air conditioner is in its operational or non-operational state.

While any of the above and like through-the-wall air conditioner covers will keep drafts out in the cold months, and when removed, or partially removed, allow for air conditioner use, covers displaying an ability to readily switch between these use and non-use states are not known. For that matter, conventional through-the-wall air conditioner covers are known to require custom fitting, and construction, are not ready-made for easy installation. Nor are such covers known to be configurable, i.e., stained or painted to aesthetically complement a room's décor or fine furniture proximate the air conditioner.

### SUMMARY OF THE INVENTION

The present invention provides a cabinet system that overcomes the shortcomings of traditional through-the-wall air conditioner covers.

In one embodiment, the invention provides a through-the-wall air conditioner cabinet system. The cabinet system includes a cabinet with a built-in angled cabinet-mounting member, and an angled wall-mounting member configured to easily attach to a wall upon or through which a through-the wall air conditioner is installed. Once the wall-mounting member is fixed to the wall, the cabinet is fixed to same by fitting the cabinet's angled cabinet-mounting member to the wall-mounting member, and is readily mounted upon or removed from its mounted position on the wall covering the air conditioner.

The cabinet is preferably constructed with wood or wood-like material. The cabinet includes four sides forming an opening at one end for placing over the air conditioner where the side ends abut against the wall surface, and a facing surface with at least one set of doors connected at the other ends of the four sides. The surface and doors are configurable, e.g., paintable, to match or complement a décor or theme of a room in which the air conditioner is installed.

Upon mounting the cabinet, the cooperation between the angled cabinet- and wall-mounting members sealably covers and isolates the air conditioner when the at least one set of doors is closed. The doors are simply opened to enable air conditioner functional operations while the air conditioner is operational. That is, the cabinet when mounted readily switches its functioning in both the use state and the non-use state of the air conditioner, while exhibiting desirable décor and ornamental design characteristics during both of the air conditioner off and on states.

The invention honors through-the-wall air conditioner function in a cabinet, and cabinet access construction. At least one set of doors is closed during non-operation to conceal the parts and portions of the installed through-the-wall air conditioner in need of covering to blend the cabinet and therefore the through-the-wall air conditioner with the room. At least one set of doors is configured to respect the need for air flow and ventilation through the installed air conditioner in an on state. For example, one embodiment of the cabinet comprises louver doors to let air flow to the part of the air conditioner that needs it, which louvr doors maintain a substantially draft-free barrier to air flow when in a closed position, utilized in the closed state when the air conditioner is non-operational.

In another embodiment, the invention comprises a combination cabinet system or kit including an easy to install angled wall-mounting member, a wood cabinet that includes therein an angled cabinet-mounting member, weather stripping, door sealing means, fasteners for fastening the angled wall-mounting member to the wall. The weather stripping seals the opening to the outside within which the air conditioner is mounted, preventing communication between the inner and outer environments. The door sealing means provides for better sealing the inner portion of the cabinet to the inner room environment when closed.

Different paints and/or stains allow for the unfinished cabinet to configured to match the décor or theme of the room in which it is to be used, i.e., where the air conditioner is installed. The paint used on the cabinet is preferably non toxic, low or no voc paint, for example, low or no voc antique white paint. Please note that invention is not limited to a particular color or stain, or even require painting or staining at all. That is, while the cabinet preferably comes in various painted colors and/or stains, the cabinet may also be sold without finish. Hence, a kit or combination sold with an unfinished cabinet might include paint or stain, and an applicator, such as a brush

The doors may be tri-fold or bi-fold doors, wherein the cabinet includes hinges on the left and right sides to facilitate full opening/closing of the doors, a neat appearance and unobstructed air flow through the cabinet enclosure opening to/from the entire air conditioner. The hinges secure the tri or bi-fold doors to each other are only visible looking inside the cabinet or when the cabinet is opened. The hinges may be painted to match the cabinet. The doors include means for maintaining the cabinet in a closed state, for example, magnetic closure means that secure to complementary closure means on the inside of the cabinet. While the angled cabinet-mounting member is preferably attached to the inner top side or surface to the cabinet in its installed position against the wall, but may very well be positioned on an outer bottom surface or side of the cabinet, as long as the angled wall-mounting member is attached to the wall in a complementary position. The angles are preferably 45 degrees, but this may vary according to need.

Depending upon the depth of the cabinet, the doors may be folded back to rest flush against the sides, where a second set of magnetic closure means may be included to maintain the doors in the open position. Each set of doors (two bi or tri-fold) will have one set of magnetic closure means (or two total per cabinet system). Preferably, one set of handles or knobs on the cabinet allow for grasping to open, close and or affix the open doors, or sets of doors in a desirable position. For example, an alternative design with the louvers and four doors will have four knobs, preferably disposed close together to appear as a single set of handles.

### BRIEF DESCRIPTION OF THE DRAWINGS

Aspects of the invention will become apparent upon reading the following detailed description and upon reference to the accompanying drawings in which, like references may indicate similar elements:

FIG. 1A is a frontal view of one embodiment of a cabinet system of the invention, wherein cabinet doors are in a closed position;

FIG. 1B is a frontal view of the FIG. 1A cabinet system, wherein the cabinet doors are in an open, folded position;

FIG. 1C is a frontal view of the FIG. 1A cabinet system, wherein one side of the cabinet doors are in a partially open position, and another side of the cabinet doors are in a fully open, but not a folded position;

FIG. 2A is a frontal view of another embodiment of a cabinet system of the invention, wherein the set of doors include an upper door and a lower louver door, and one of the upper doors is in an open, folded position;

FIG. 2B is a frontal view of the FIG. 2A cabinet system, where both sides of the doors are open, but not folded, to highlight features of the cabinet system including a latchable internal cover;

FIG. 3A depicts a side view of wall mounting member mounted to a wall, and side cutaway view of a cabinet including angled cabinet-mounting member, pre-mounting;

FIG. 3B is a side view of the wall mounting member and side cutaway view of a cabinet including angled cabinet-mounting member, post-mounting;

FIG. 3C is a side perspective view of a wall-mounting member, highlighting pre-drilled holes for receiving fasteners;

FIG. 3D depicts an embodiment of the invention including bi-fold doors, one side of which is open to highlight an internal mat (rubber, plastic, cloth) cover that is attached by Velcro or other known attaching means.

### DETAILED DESCRIPTION OF THE PREFERRED EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention, as defined by the appended claims. The descriptions below are designed to make such embodiments obvious to a person of ordinary skill in the art.

The invention comprises a cabinet system including a cabinet constructed to be wall mounted to envelop varying sized through-the-wall air conditioners installed in the wall. The cabinet structure comprises five sides, for sealable connection/abutment to a wall surrounding an opening through which a through-the-wall air conditioner is installed. An outline or footprint of the mounted cabinet is larger than the wall opening so that the cabinet fully encloses the air conditioner and opening.

While preferably constructed of cedar or pine, the cabinet structure, including the doors, may be constructed from any type of solid material, i.e., wood, or man-made materials. The cabinet structure is not just functional, but decorative in such a way that it coordinates with a natural décor of a room in which it is used, whether it is installed without stain or paint, or painted for room color coordination. For that matter, an important feature of the cabinet system, besides its inherent user-configurable thematic feel, resides in the cabinet's ease of attachment, and removal to the wall once installed as a system.

That is, each cabinet of the cabinet system is constructed with an angled cabinet-mounting member internally affixed and configured to abut against and cooperate with an angled wall-mounting member, after the angled wall-mounting member is affixed to a wall directly proximate the installed air conditioner. The angled cabinet-mounting member (and cabinet) is positioned to slip down upon and into a triangular opening left by the angled wall-mounting member as the cabinet is mounted to the over the through-the-wall-mounted air conditioner. The triangular opening between the wall and the upper edge of the angled wall mounting member receives the triangular part of the angled cabinet-mounting member.

In a commercial product kit or combination, the invention includes not only the cabinet, wall mounting member and fasteners for attaching the angled wall-mounting member, but also includes any combination of hooks, sealant or weather strips, insulating mats, Velcro pads and/or instructions for mounting and use. Different kits may further include paint and/or stain and a brush, tools, etc.

The cabinet is available in various sizes in order to accommodate through-the-wall air conditioners ranging from 4000 to 24000 BTUs, for example, inner dimensions of 32×5½×23⅞ inches, with a height from the bottom of the angled cabinet-mounting member to the inner bottom side being 21 inches, and outer dimensions of 34×29½ (with moulding)×7¾ (moulding to moulding). The door panel thickness is preferably ¾ inch, and the inside frame thickness is preferably 1 inch.

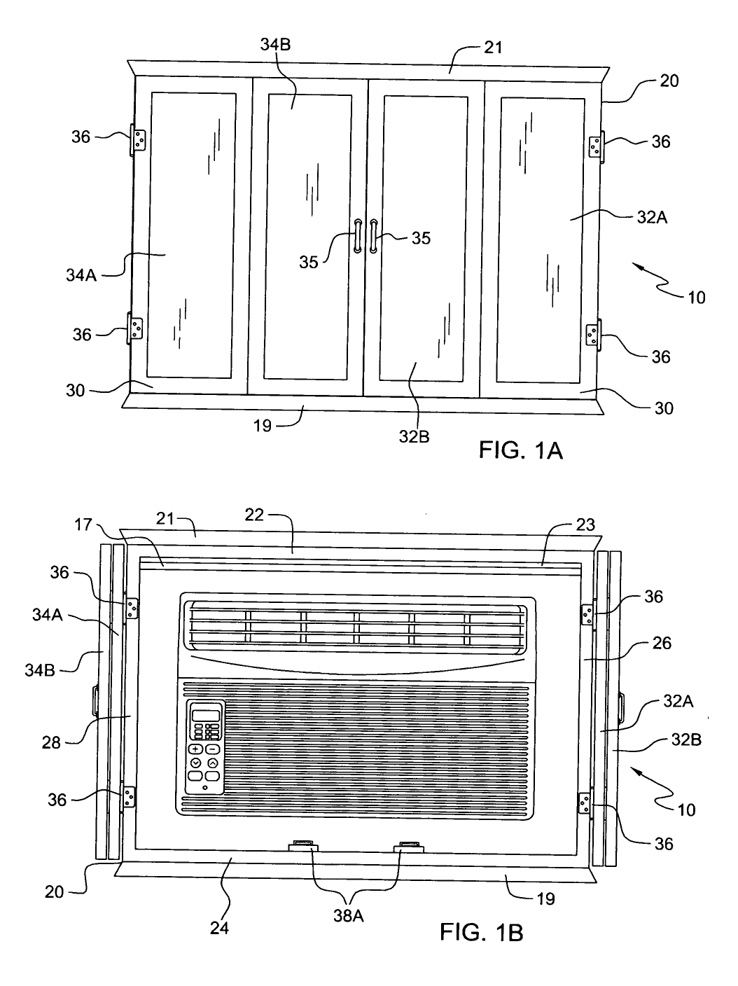

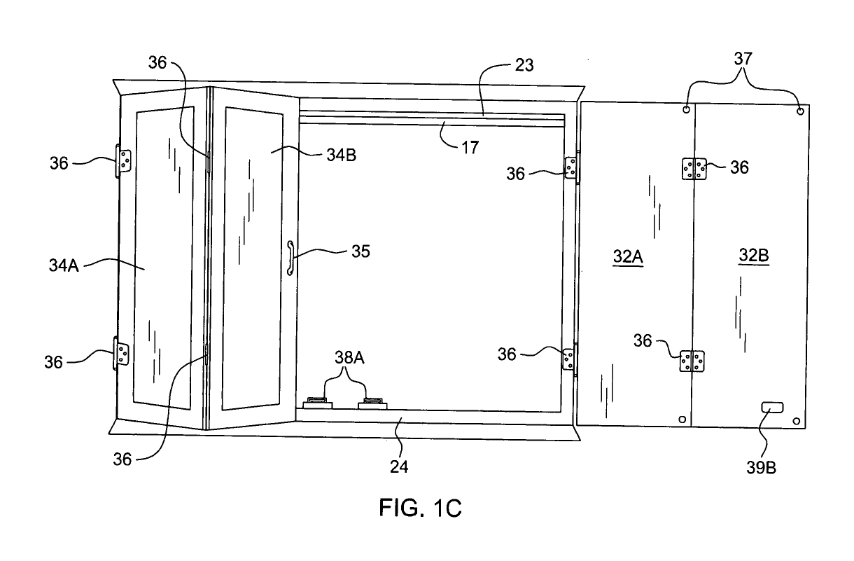

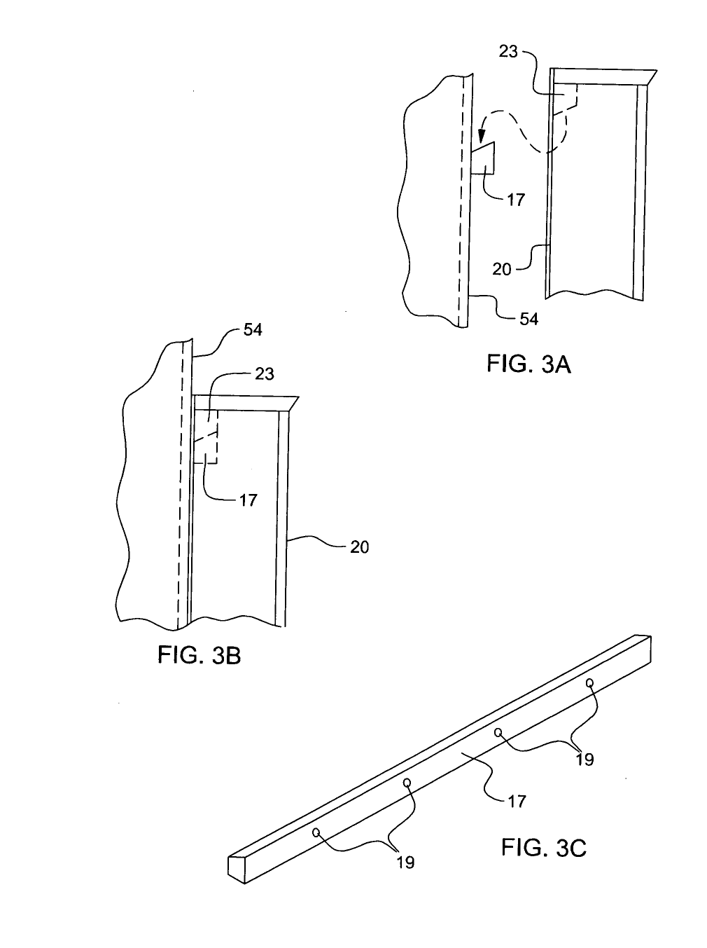

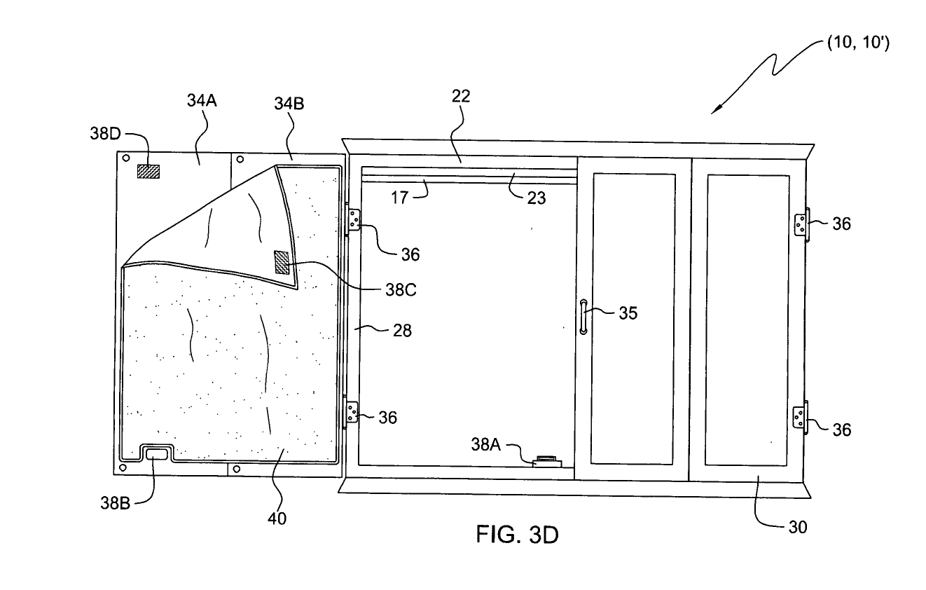

FIGS. 1A, 1B and 1C together depict a first embodiment of a cabinet system (10) of the invention. The cabinet system (10) includes a cabinet structure (20) formed with planar top portion or side (22), a planar bottom portion or side (24), a planar left side portion (26), a planar right side portion (28) and an outer facing surface (30). These portions interconnect at respective ends to form the rectangular cabinet structure (20). Preferably, the cabinet structure (20) includes a top moulding (21) and a bottom moulding (19). A wall-connecting end of each of the top, bottom, left and right portions contacts the wall (see FIG. 3A). These wall connecting ends are the proximate locations for installing the weather-stripping (42) on left, right, top and bottom sides of the cabinet structure.

An angled wall-mounting member (23) is attached to planar top portion (22), and arranged to cooperate with an angled wall-mounting member (17), after the angled wall-mounting member has been attached to the wall, as seen in FIGS. 1B, 1C, 3A, 3B. When mounted and affixed to the wall by use of the complementary wall- and cabinet-mounting members, the planar side portions extend out from the wall to surface cover contacting ends, at a distance at least to the furthest point that the mounted air conditioner extends out from the wall. The cover contacting ends contact with outer facing surface (30), which as shown in FIGS. 1A, 1B and 1C further comprises a set of left (32) and right (34) front bi-fold doors.

FIG. 1A highlights the cabinet system (10) and cabinet structure (20) with the bi-fold doors (32A, 32B; 34A, 34B) in a closed state. While bi-folds doors are shown, the invention is not limited to the doors shown. The surface may comprise any number of doors, for example, louver doors, sliding doors, half doors, ⅓-⅔ doors, etc., without deviating from the scope and spirit of the invention. The bi-fold doors depicted in the figures are preferably mounted to the side portions (26; 28) with hinges (36), where each side of the door set is opened and closed using handles (35), as shown.

Where the cabinet structure (20) is made substantially from solid woods, the wood may be stained to match a stain of furniture comprising a room in which the cabinet system (10) is put to use. But in many cases, however, the wood or non-wood materials comprising a cabinet structure (20) may be painted with non toxic, low voc paint, of varying colors, or color combinations to highlight the them or décor of the room.

FIG. 1B highlights the cabinet system (10) and cabinet structure (20) with the doors (32A, 32B; 34A, 34B) in an open and secured (folded) state, minimizing the space taken up by the open doors. FIG. 1C highlights the cabinet system (10) and cabinet structure (20) with the doors (32A, 32B) in an open and unsecured state, and doors (34A, 34B) in a partially open state. As is further shown, latches (38A) are included inside the cabinet structure (20) on an up-facing surface of bottom side (24), which cooperate with complementary latches (38B; 39B). Weather-stripping (42) may be attached to the inner left, right and bottom of cabinet structure, on the sides that lay flush against the wall.

The top of the cabinet structure (20) may be utilized as a shelf for decorative items to further enhance the look of the room where the air conditioner unit is mounted. The inner planar bottom portion (24) functions as an inner cabinet shelf and may be utilized to store the detachable insulated mats, the ac manual, etc. There is also a cord cut-out on the bottom shelf for the a/c cord to access the wall outlet. It can then be tucked up on the inner bottom shelf of the cabinet during the colder months when not in use. In a simple form, the latch pairs are magnetic, the attraction between the complementary latching parts (38A; 38B) being sufficient to seal the doors in a closed state whereby drafts are prevented. In harsh climates, each door may be configured to have more than one latch system (38), for example, one set for each of the four (4) bi-fold door sections.

There is a self-adhesive, sticky-back type of weather seal tape made of durable plastic or rubber, adhered along the left, right and bottom sides of the cabinet structure, that rests against the wall. The simplicity of the cabinet from the exterior, gives the appearance of a lovely decorative addition to the room (all year long), with the top of the cabinet having the ability of being utilized as a decorative shelf This lovely decorative cabinet is displayed in the consumer's home, instead of the unsightly look of a drab air conditioner unit, all year long. Finally, when that cabinet is opened, to reveal the air conditioner unit, it is apparent that much more went into this beautiful, functional cabinet than some pieces of wood put together.

Considering the ease of use factor for the consumer, the mounting cabinet may be sold as a combination kit for ready installation in three simple steps. The first step or act requires locating wall beams. The second step requires securing the angled mounting beam (included in kit) to the wall using the included screws and anchors, and the third step includes placing the cabinet onto the mounting member to cover the air conditioner. It is as simple as that. The cabinet can be easily lifted on and off of the wall, yet sits securely on an angled beam, angled towards the wall.

In a kit embodiment, the combination includes 1 cabinet with the angled cabinet-mounting member and all the hardware pre-installed, weather sealing tape pre-adhered, 1 angled wall-mounting member, 4 mounting screws and anchors, simple and complete instructions, and 2 detachable insulated mats, with Velcro. The kit may further comprise weather stripping, paints, brushes, stains, etc, to allow for the homeowner to configure the décor or theme of the cabinet to match or complement the décor or theme of the room in which the air conditioner is installed.

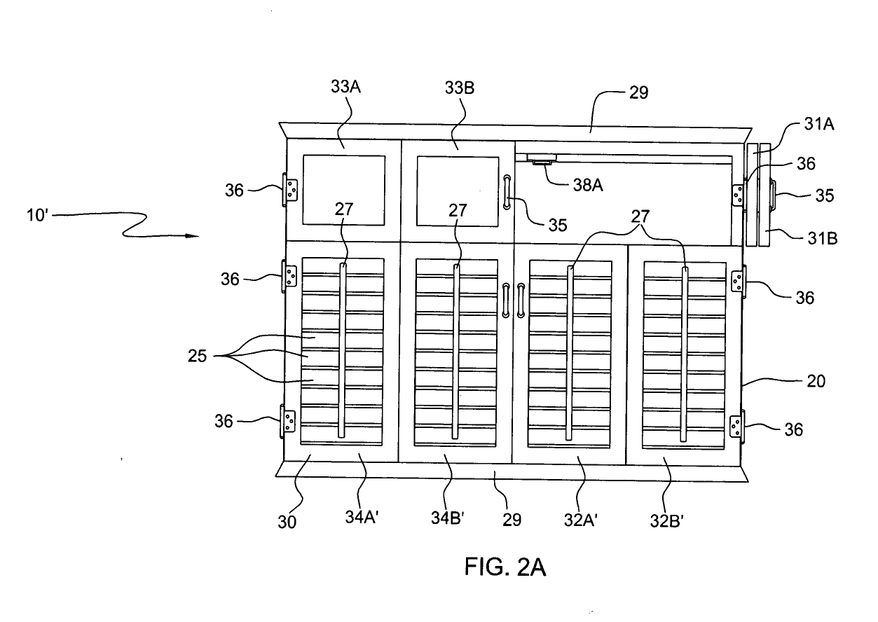

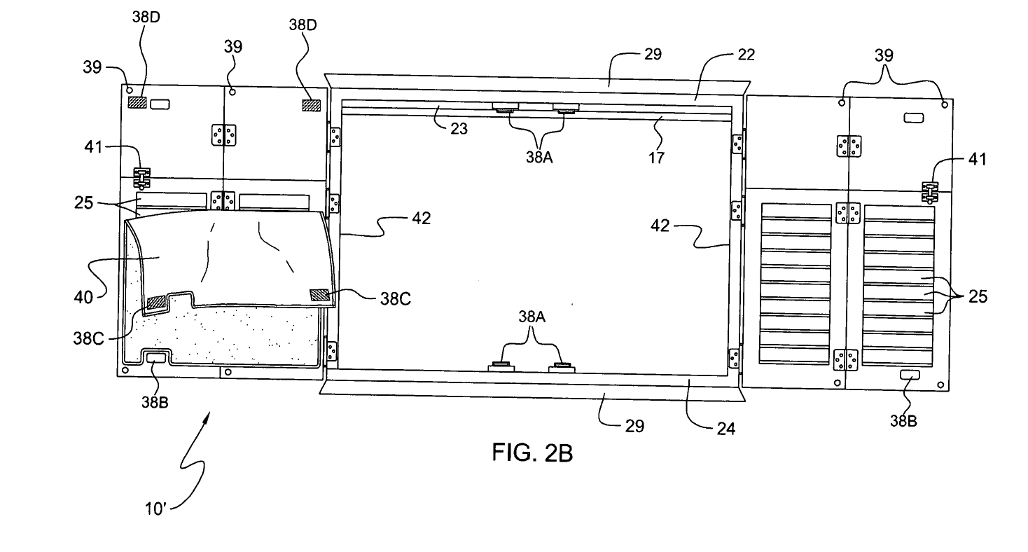

FIGS. 2A and 2B depict an alternative cabinet structure (20) where left (32A; 32B) and right (34A; 34B) solid bi-fold doors of FIGS. 1A, 1B and 1C, are replaced with a set of right (top ⅓ and bottom ⅔) and a set of left (top ⅓ and bottom ⅔) bi-fold doors. For example, if the length of the doors opening is 24 inches tall, the top solid door could be 8 inches tall and the bottom set of shutter doors with movable louvers would be 16″ tall. The option of a top ⅓ set of doors and a bottom ⅔ set of shutter type doors with movable louvers, gives the consumer the opportunity to open only the top set of doors, when a/c is in use, allowing the cold air to flow into the room. The left upper door set comprising door panels (31A, 31B) and right upper doors set comprising door panels (33A, 33B) are shown that utilize latching means (41) to detachably connect to door panels (32A′, 32B′; 34A′, 34B′).

Hence, a user may choose to open the doors fully and together, to completely expose the air conditioner unit, for example, while in use. The top set of doors will cover a top portion of the air conditioner, for example, a top third. Accordingly, the cabinet doors may be operated so that only the top set of doors are open to let the cool air flow through, wherein the louvers (25) on the bottom set of doors may be opened using control levers (27) to allow for ventilation to sealing close the gap between the upper and lower doors, particularly in a closed state.

A detachable latchable insulated cover (40) may be drawn across the entire set of left doors, and the entire set of right doors to provide a barrier to drafts in a closed state, particularly in view of the fact that louvers are known to have limited sealing ability (i.e., can be drafty). The detachable mats (40) attach using Velcro patches (38C) attached to the cover, and attached to the door (38D). The detachable mats or covers may be completely detached, and stored on the inner bottom shelf of the cabinet during the warmer months. To further support sealing, the FIGS. 2A, 2B embodiment includes weather sealant tape insulating means (42) along edges of sides 22, 24, 26, 28. The weather insulating means (or weather stripping) may be disposed at any two opposing surfaces to facilitate sealing when contacted, with or without the additional attaching means.

FIGS. 3A, 3B and 3C together highlight the complementary angled wall- and cabinet-mounting members, for ease of mounting and removing the cabinet from the wall. FIG. 3A depicts a side view of an angled wall-mounting member (17) mounted to a wall (54). A side cutaway view of a cabinet structure (20) including angled cabinet-mounting member 23, before mounting. FIG. 3B is a side view of the wall mounting member (17) and side cutaway view of a cabinet structure (20) including angled cabinet-mounting member 23 after the cabinet is mounting by positioning the cabinet and cabinet-mounting member (23) into the opening between the wall (54) and the angled top of angled wall-mounting member (17), post-mounting. FIG. 3C is a side perspective view of a wall-mounting member (17), highlighting pre-drilled holes (19) for receiving fasteners.

And as mentioned above, a kit embodiment includes the cabinet structure (20), angled cabinet-mounting member (23), angled wall-mounting member (17) and fasteners (not shown) needed to attach the angled wall-mounting member to the wall using pre-drilled openings (19). Use of the angled wall-mounting member (17) allows the user to merely fix same to a wall, and thereafter attach and remove the cabinet structure (20′) to it via complementary angled cabinet-mounting member (23), which is pre-assembled. Alternatively, the kit may include the cabinet structure and angled cabinet-supporting member (23) as separate pieces, where assembly is required.

FIG. 3D depicts a solid-door cabinet structure with at least one detachable insulated mat (40). Shown partially attached to the inside of the Right side bi-fold doors (34A; 34B) of the cabinet system (10, 10′). The consumer will attach four squares of Velcro to the interior of the doors (38D), and opposing Velcro squares (38C) to the insulated mat (40), or the mats will pre-configured with the Velcro pre-attached. The consumer will then have the option of attaching the mats (40) to the doors during the colder months when the air conditioner unit is not being used. This further insulates the cabinet, by insulating the doors and covering the space between the bi or tri-fold doors, keeping cold air out of the room, thereby retaining heat and the consumers hard earned money, in their home. There is a cord cut-out in the bottom shelf of the cabinet that is used for the air conditioner wire to access the wall outlet, while allowing the cabinet to rest flush against the wall.

Although examples of the present invention have been shown and described, it would be appreciated by those skilled in the art that changes may be made in these embodiments without departing from the principles and spirit of the invention, the scope of which is defined in the following claims and their equivalents

What is claimed is:

1. A cabinet for covering an air conditioner mounted upon and extending through an opening in a wall separating an enclosed inside environment from an outside environment, the cabinet comprising;
a planar top portion, a planar left side portion connected at an upper end to first end of the planar top portion, a planer bottom portion disposed opposite the planar top portion and connected at a first end to a lower end of the planar left side portion, and a planar right side portion connected at a lower end to a second end of the planar bottom portion and at an upper end to a second end of the planar top portion, wherein a face end of each of the planar top, planar bottom, planar left side and planar right side portions is connected to an outer facing surface and wherein wall connecting ends of each of the planar top, planar bottom, planar left side and planar right side portions is configured to be sealably fixed to the wall to enclose the air conditioner;
at least one angled cabinet-mounting member attached to at least one of the planar top portion, the planar bottom portion, the planar left side portion and the planar right side portion, configured to meet and couple with at least one angled wall-mounting member that is pre-attached to the wall, thereby securing the cabinet to the wall; and
at least one set of doors attached to said outer facing surface of the cabinet that are configured to be opened and closed, wherein in an open door state facilitate active air conditioner operation and wherein in a closed door state prevent communication of the outside environment with the inside environment.

2. The cabinet as set forth in claim 1, wherein the planar top portion, planar bottom portion, planar left side portion, planar right side portion, outer facing surface and at least one set of doors comprise wood.

3. The cabinet as set forth in claim 2, wherein the planar top portion, planar bottom portion, planar left side portion, planar right side portion, outer facing surface and at least one set of doors are painted with low voc paint or stained.

4. The cabinet as set forth in claim 1, further comprising weather stripping attached to wall connecting ends of the planar top portion, planar bottom portion, planar left side portion, and planar right side portion of the cabinet.

5. The cabinet as set forth in claim 1, further comprising a mat that is attachable across an inner portion of the cabinet to insulate openings in the doors against drafts.

6. The cabinet as set forth in claim 1, wherein the outer facing surface and at least one set of doors are configured to exhibit desirable décor and ornamental design characteristics.

7. The cabinet as set forth in claim 1, wherein the at least one set of doors are louver doors.

8. The cabinet as set forth in claim 1, wherein the at least one set of doors are bi-fold doors.

9. The cabinet as set forth in claim 1, wherein the at least one set of doors are tri-fold doors.

10. The cabinet as set forth in claim 1, wherein the at least one set of doors comprise magnetic closure means, and wherein complementary magnetic closure means are arranged on a portion of the outer facing surface.

11. The cabinet as set forth in claim 10, wherein said at least one set of doors further comprises a second set of magnetic closure means for maintaining the doors in the open position.

12. The cabinet as set forth in claim 7, wherein the at least one set of louver doors are shutter type doors allowing a top portion to open while a bottom portion is closed, and vice versa.

13. The cabinet as set forth in claim 1, wherein the planar top portion is configured as a shelf for decorative items.

14. A combination through-the-wall air conditioner covering cabinet and apparatus for cooperating with the covering cabinet and enable it to be removably mounted to cover an air conditioner installed upon and extending through an opening in a wall separating an enclosed inside environment from an outside environment,
the covering cabinet comprising:
a planar top portion, a planar left side portion connected at an upper end to first end of the planar top portion, a planer bottom portion disposed opposite the planar top portion and connected at a first end to a lower end of the planar left side portion, and a planar right side portion connected at a lower end to a second end of the planar bottom portion and at an upper end to a second end of the planar top portion, wherein a face end of each of the planar top, planar bottom, planar left side and planar right side portions is connected to an outer facing surface and wherein a wall contacting end of each of the planar top, planar bottom, planar left side and planar right side portions is configured to abut against the wall to sealingly enclose the air conditioner upon mounting of the covering cabinet;
at least one angled cabinet-mounting member attached to at least one of the planar top portion and the planar bottom portion configured to meet and couple with at least one angled wall-mounting member upon fixation of the at least one angled wall-mounting member to the wall; and
at least one set of doors attached to said outer facing surface of the covering cabinet and configured to be opened and closed, wherein in an open door state facilitate active air conditioner operation and wherein in a closed door state prevent communication of the outside environment with the inside environment;
the apparatus comprising:
at least one an angled wall-mounting member configured to be fastened to the wall for meeting and coupling with the at least one angled cabinet-mounting member fixed within the covering cabinet upon placement of the covering cabinet to cover the air conditioner;
fasteners for securing the angled wall-mounting bracket to the wall;
weather stripping for attaching to at least the planar top portion, planar bottom portion, planar left side portion, planar right side portion of the covering cabinet; and
at least one of: paint, stain, a paint brush, caulking, a tool for driving the fastening screws, a level, a ruler, nails, a hammer.

15. The combination as set forth in claim 14, wherein the at least one set of doors are louver doors.

16. The combination as set forth in claim 14, wherein the at least one set of doors are one of bi-fold doors and tri-fold doors.

17. The combination as set forth in claim 14, wherein the at least one set of doors comprise magnetic closure means, and wherein complementary magnetic closure means are arranged on a portion of the outer facing surface.

18. A method for installing a cabinet to cover a through-the-wall air conditioner installed and extending through an opening in a wall separating an enclosed inside environment from an outside environment;
wherein the cabinet comprises:
a planar top portion,
a planar left side portion connected at an upper end to first end of the planar top portion,
a planer bottom portion disposed opposite the planar top portion and connected at a first end to a lower end of the planar left side portion,
a planar right side portion connected at a lower end to a second end of the planar bottom portion and at an upper end to a second end of the planar top portion,
wherein a face end of each of the planar top, planar bottom, planar left side and planar right side portions is connected to an outer facing surface, and
wherein wall connecting ends of each of the planar top, planar bottom, planar left side and planar right side portions are configured to abut against and sealably enclose the air conditioner,
at least one angled cabinet-mounting member attached to at least one of the planar top portion and the planar bottom portion, and configured to meet, couple with and cooperate with at least one angled wall-mounting member having been fixed to the wall in order to secure the cabinet to the wall, the method comprising acts of:
locating vertical support beams comprising the wall and proximate the installed air conditioner;
securing the at least one angled wall-mounting member to the vertical support beams using fasteners; and
removably fixing the cabinet to the angled wall-mounting member the angled cabinet-mounting member comprising the cabinet.

19. The method as set forth in claim 18, wherein the step of removably fixing includes substantially sealing any air gaps between the cabinet and the wall.

20. The method as set forth in claim 18, further comprising using any of various colored paint or various stains to enhance the outer character of the cabinet in order that it complement a décor of the room.
